(19) United States
(12) Patent Application Publication
(10) Pub. No.: US 2007/0128949 A1
(43) Pub. Date: Jun. 7, 2007

(54) High frequency coaxial jack

(75) Inventors: Steven R. Cooper, Round Lake Beach, IL (US); Zenon Sliczniak, Saint Charles, IL (US)

Correspondence Address: SCHIFF HARDIN, LLP;PATENT DEPARTMENT, 6600 SEARS TOWER, CHICAGO, IL, 60606-6473, US

(73) Assignee: Switchcraft, Inc.

(21) Appl. No.: 11/296,792

(22) Filed: Dec. 7, 2005

(51) Int. Cl. H01R 24/04

(52) U.S. Cl. 439/668

(57) ABSTRACT

A switching coaxial jack has at least first, second, and third coaxial center conductors, a switch, and a cam. The switch has a first position that electrically couples the first and second center conductors to one another and a second position that electrically couples the first and third center conductors to one another. A cam is responsive to a plug inserted into the jack to apply a lateral force against the plug and/or to operate the switch between its first and second positions.

### TECHNICAL FIELD OF THE INVENTION

The present invention relates to coaxial jacks and, more particularly, to switching type coaxial jacks.

### BACKGROUND OF THE INVENTION

Switching coaxial jacks are well known as shown in U.S. Pat. No. 6,045,378. Such coaxial jacks generally include two center conductors disposed within corresponding ports at a first end of a grounded electrically conductive housing, and two center conductors disposed within corresponding ports at an opposite second end of the grounded electrically conductive housing. Each center conductor at the first end of the housing is generally aligned with a corresponding one of the two center conductors at the second end of the housing. A switch is also provided in the housing.

When no plug is inserted into a port at the first end of the housing, the switch couples the two center conductors at the second end of the housing together. However, when a plug is inserted into a port at the first end of the housing, the switch couples the center conductor in that port to the aligned center conductor at the second end of the housing. Also, the switch may be arranged to terminate the other center conductor at the second end of the housing to ground through a terminating resistor.

Such video jacks have a number of problems. For example, the contacts of the switch typically used in prior art jacks are unreliable, particularly in dusty environments. Also, many prior art jacks use switches having leaf springs that reduce the life expectancy of the jacks. Additionally, prior art jacks cannot be easily re-configured for different applications.

Moreover, a plug inserted into a port at the first end of the housing must travel a substantial distance in its port before the switch couples the center conductor in that port to the opposing center conductor at the second end of the housing, which delays the signal on the center conductor from being received by the plug. Furthermore, vibration and/or other forces applied to the housing sometimes cause electrical disengagement of the plug from the jack.

Also that, in some jacks, the contacts in the housing are not sufficiently isolated electrically from one another and, thus, produce cross-talk.

The jack of the present invention overcomes one or more of these or other problems.

### SUMMARY OF THE INVENTION

In accordance with an aspect of the present invention, a switching coaxial jack comprises an electrically groundable housing, first, second, third, and fourth center conductors, a terminating element, a switch, and a cam. The electrically groundable housing supports first and second connectors at a first end of the housing and third and fourth connectors at a second end of the housing. The first center conductor is disposed within the first connector. The second center conductor is disposed within the second connector. The third center conductor is disposed within the third connector. The fourth center conductor is disposed within the fourth connector. The terminating element is within the housing. The switch is within the housing, the switch has a first position that electrically couples the third center conductor to one of the fourth center conductor and the terminating element, and the switch has a second position that electrically couples the first and third center conductors to one another. The cam is within the housing such that a plug, inserted into one of the connectors, causes the cam to operate the switch between the first and second positions and causes the cam to apply a lateral biasing force against the plug when the plug is in the one connector.

In accordance with another aspect of the present invention, a switching coaxial jack comprises an electrically groundable housing, a switch, a non-contact spring, and a cam. The electrically groundable housing supports at least first, second, and third coaxial connectors, the first coaxial connector includes a first center conductor disposed therein, the second coaxial connector includes a second center conductor disposed therein, and the third coaxial connector includes a third center conductor disposed therein. The a switch is within the housing and is movable between first and second positions so as to control switching of the first, second, and third center conductors. The cam is within the housing such that a plug, inserted into one of the connectors, causes the cam to operate the switch between the first and second positions.

In accordance with still another aspect of the present invention, a switching coaxial jack comprises an electrically groundable housing, a switch, and a cam. The electrically groundable housing supports at least first, second, and third coaxial connectors, the first coaxial connector includes a first center conductor disposed therein, the second coaxial connector includes a second center conductor disposed therein, and the third coaxial connector includes a third center conductor disposed therein. The switch is within the housing and is movable between first and second positions so as to control switching of the first, second, and third center conductors. The cam is within the housing such that a plug, inserted into one of the connectors, causes the cam to apply a lateral biasing force against the plug when the plug is in the one connector.

### BRIEF DESCRIPTION OF THE DRAWINGS

These and other features and advantages will become more apparent from a detailed consideration of the invention when taken in conjunction with the drawings in which:

FIG. 1 is an isometric view of a video jack according to one embodiment of the present invention;

FIG. 2 shows the video jack of FIG. 1 with the cover removed and a plug inserted;

FIG. 3 is an isometric view of a first embodiment of the video jack illustrated in FIG. 1 and shows the inside of the cover and a printed circuit board with sliding contacts that form the switch of the video jack, where the switch is in a first switch position;

FIG. 4 is the same isometric view as FIG. 3 but where the switch is in a second switch position;

FIG. 5 is an isometric view similar to FIG. 4 showing switch controlling sliders, a plug, and a cam;

FIG. 6 is an isometric view of the jack of FIG. 1 with the cover and the printed circuit board removed and a plug inserted;

FIG. 7 is an exploded view of the video jack of FIGS. 1-6;

FIG. 8 is an isometric view of another embodiment of the video jack illustrated in FIG. 1 and shows the inside of the cover and a printed circuit board with sliding contacts that form the switch of the video jack, where the switch is in a first switch position;

FIG. 9 is the same isometric view as FIG. 8 but where the switch is in a second switch position;

FIG. 10 is an isometric view of the inside of the cover of the video jack of FIGS. 1-5 and shows cams according to one embodiment of the cover;

FIG. 11 is an isometric view of the inside of the cover of the video jack of FIGS. 1-5 and shows cams according to another embodiment of the cover;

FIG. 12 is an enlarged illustration of the cams of FIGS. 5, 6, 7, 10 and 11;

FIG. 13 is an isometric view similar to FIG. 5 showing switch controlling sliders, a plug, and a cam; and,

FIG. 14 illustrates a plurality of the video jacks shown in FIGS. 1-13 coupled to a patchbay.

### DETAILED DESCRIPTION

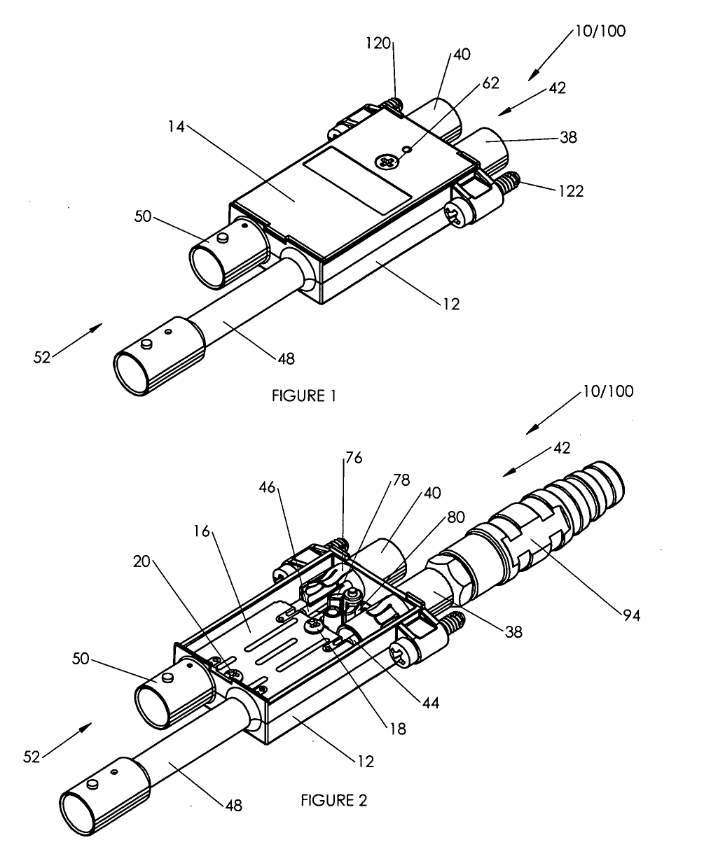

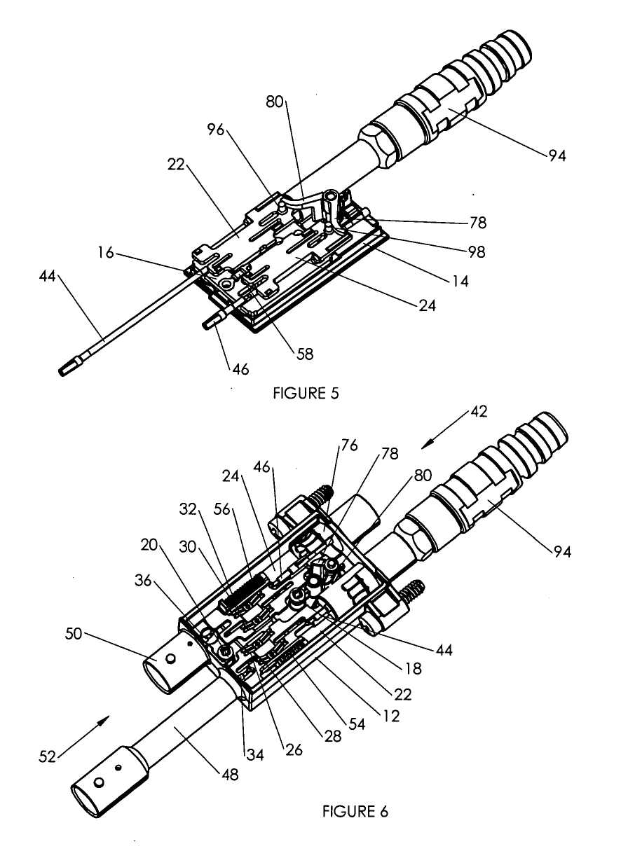

A dual self-terminating video jack 10 according to one embodiment of the present invention is shown in FIGS. 1-7. The dual self-terminating video jack 10 includes a housing 12 that can be closed with a cover 14. The housing 12 and the cover 14 are capable of being electrically grounded. A printed circuit board 16 is fastened to the housing 12 by screws 18 and 20. Sliders 22 and 24 (FIGS. 5, 6, and 7) are provided within the housing 12. Sliding contacts 26 and 28 are suitably affixed to the slider 22, and sliding contacts 30 and 32 are suitably affixed to the slider 24. Accordingly, the sliding contacts 26 and 28 move as the slider 22 moves, and the sliding contacts 30 and 32 move as the slider 24 moves. The sliding contacts 26, 28, 30, and 32 may be spring-type, bifurcated contacts.

Center conductors 34 and 36 are provided within corresponding connector ports 38 and 40 at a first end 42 of the dual self-terminating video jack 10, and center conductors 44 and 46 are provided within corresponding connector ports 48 and 50 at a first end 42 of the dual self-terminating video jack 10. The connector ports 38 and 40 with their corresponding center conductors 34 and 36 are arranged to receive coaxial connectors, such as WECO plugs, and the connector ports 48 and 50 with their corresponding center conductors 44 and 46 are arranged to receive coaxial connectors, such as BNC connectors.

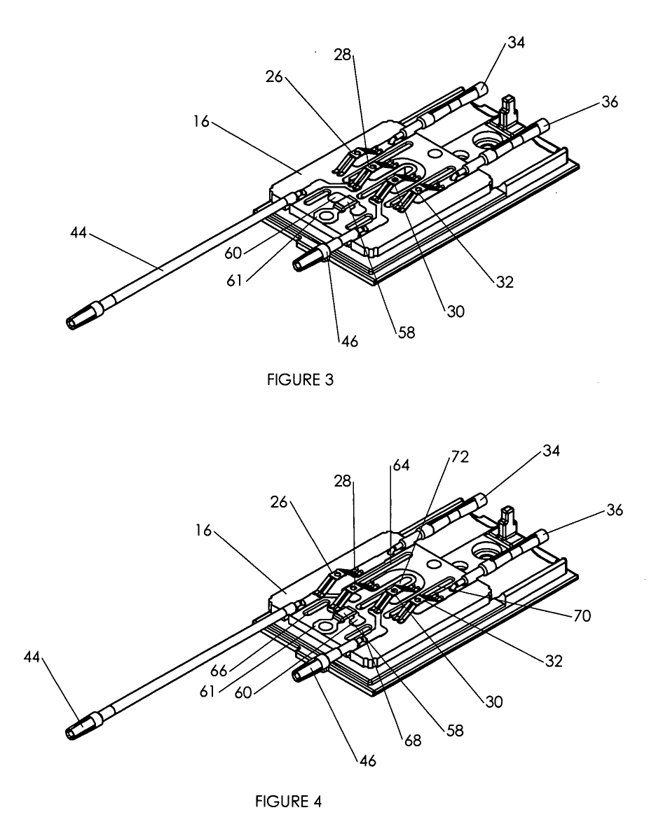

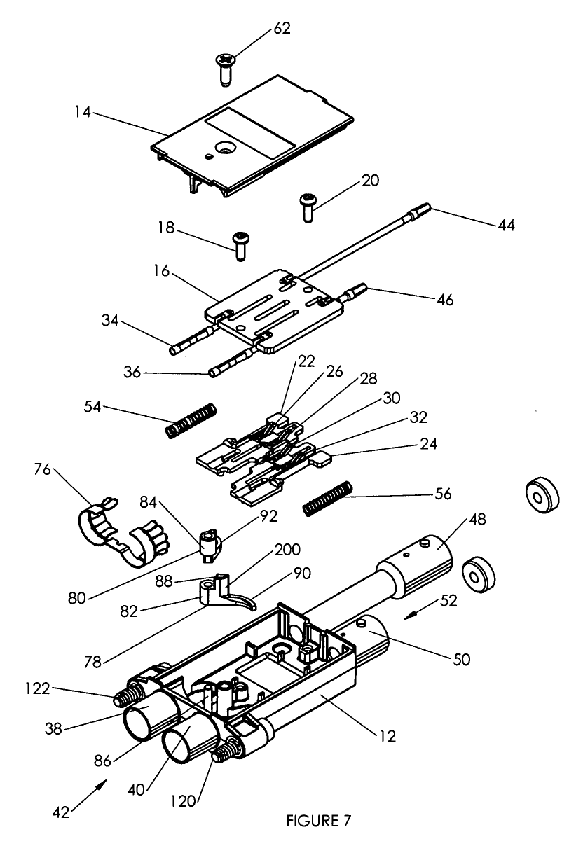

A spring 54 (FIGS. 6 and 7) normally biases the slider 22 toward the first end 42 and away from the first end 42 of the dual self-terminating video jack 10. Similarly, a spring 56 normally biases the slider 24 toward the first end 42 and away from the second end 52 of the dual self-terminating video jack 10. Accordingly, as shown in FIG. 3, the sliding contacts 28 and 30, in combination with conducting traces on the printed circuit board 16, normally couple the center conductors 44 and 46 together. Also, the sliding contact 26 does not make a connection between the substantially aligned center conductors 34 and 44, and the sliding contact 32 does not make a connection between the substantially aligned center conductors 36 and 46.

A terminating resistor 58 is coupled between a metal trace 60 on the printed circuit board 16 and the housing 12 by way of a metal trace 61 and the screw 20. A screw 62 (FIGS. 1 and 7) fastens the cover 14 to the housing 12. In one embodiment of the cover 14 shown in FIG. 11, the cover 14 has grounding fins 64, 66, 68, 70, and 72 that protrude through corresponding slots in the printed circuit board 16 (FIGS. 3 and 4) when the cover 14 is fastened to the housing 12. The grounding fins 64, 66, 68, 70, and 72 electrically isolate the conductor traces on the printed circuit board 16 from one another and electrically isolate the sliding contacts 26, 28, 30, and 32 from one another. The cover 14 of the dual self-terminating video jack 10 also has a grounding fin 74. The grounding fin 74 locates and holds a grounding clip 76 (FIGS. 2, 6, and 7).

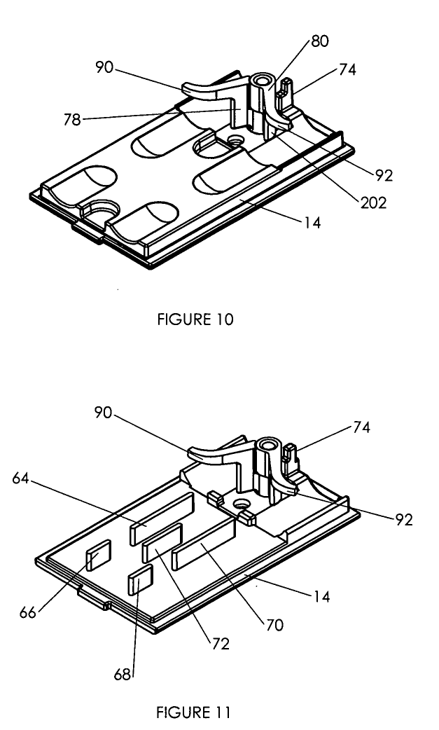

In another embodiment of the cover 14 shown in FIG. 10, the cover 14 does not have the grounding fins 64, 66, 68, 70, and 72.

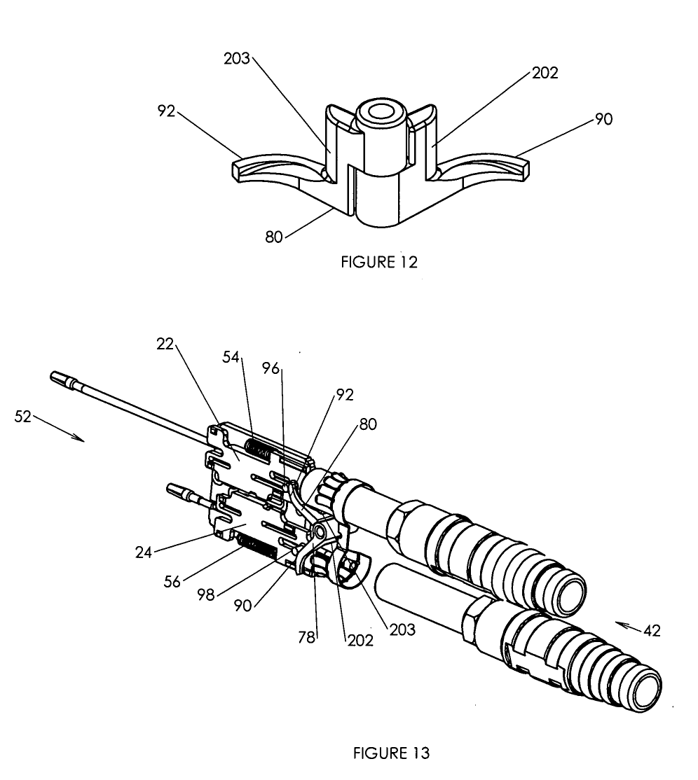

The dual self-terminating video jack 10 also has a pair of cams 78 and 80. As shown at least in FIGS. 7, 10, 11, 12, and 13, the cam 78 has a cylindrical post receiving portion 82, and the cam 80 has a cylindrical post receiving portion 84. During assembly, the cam 78 is inserted into the housing 12 so that a post 86, extending up from the floor of the housing 12, is received through a post receiving hole that extends lengthwise through the center of the post receiving portion 82. Then, the cam 80 is inserted into the housing 12 so that the post 86 is received through a post receiving hole that extends lengthwise through the center of the post receiving portion 84, and so that the post receiving portion 84 abuts the post receiving portion 82. The cam 78 also has an arcuate vertical wall 88 that extends up alongside the post receiving portion 84 and that conforms with the outer arcuate perimeter of the post receiving portion 84 to permit the cam 80 to freely rotate as a plug is inserted into the connector port 38. The cam 78 has a biasing arm 90 and a cam surface 202, and the cam 80 has a biasing arm 92 and a cam surface 203.

Initially, with no plug inserted into the dual self-terminating video jack 10, the cams 78 and 80 are unbiased. When a plug 94 is inserted into the connector port 38 as shown in FIGS. 2, 5, and 13, the plug 94 first engages the cam surface 203 of the cam 80 causing the cam 80 and the biasing arm 92 to rotate about the post 86. As the cam 80 and the biasing arm 92 rotate, the biasing arm 92 engages a post 96 on the slider 22 causing the slider 22 to move against the spring 54 toward the second end 52. The spring 54 compresses thereby exerting a biasing force on the cam 80. As shown in FIG. 4, movement of the slider 22 causes the sliding contact 26, in combination with conducting traces on the printed circuit board 16, to establish a connection between the center connectors 34 and 44. Movement of the slider 22 also causes the sliding contact 28 to disconnect the center conductor 44 from the center conductor 46 and instead to connect the center conductor 36 to the housing 12 through the sliding contact 30, traces on the printed circuit board 16, and the terminating resistor 58. The slider 24 is unmoved.

Accordingly, the plug 94 begins moving the slider 22 earlier in its travel than if the cam 80 were not present. Thus, an electrical circuit is established between the center connectors 34 and 44 sooner during the travel of the plug 94, and an electrical signal can be transferred between these center conductors earlier than would otherwise be the case. Also, the force applied to the cam 80 by the spring 54 causes the cam surface 203 of the cam 80 to apply a lateral biasing force against the plug 94 to help keep the plug 94 seated in the connector port 38 in spite of vibrations and/or shocks that may be applied to the dual self-terminating video jack 10.

On the other hand, although not shown in the drawings, when a plug is inserted into the connector port 40, the plug first engages the cam surface 202 of the cam 78 causing the cam 78 and biasing arm 90 to rotate about the post 86. As the cam 78 and biasing arm 90 rotate, the biasing arm 90 engages a post 98 on the slider 24 causing the slider 24 to move against the spring 56 toward the second end 52. Movement of the slider 24 causes the sliding contact 32, in combination with conducting traces on the printed circuit board 16, to establish a connection between the center connectors 36 and 46. Movement of the slider 24 also causes the sliding contact 30 to disconnect the center conductor 44 from the center conductor 46 and instead to connect the center conductor 44 to the housing 12 through the sliding contact 28, traces of the printed circuit board 16, and the terminating resistor 58. The slider 22 is unmoved.

Similarly, this plug begins moving the slider 24 earlier in its travel than if the cam 78 were not present. Thus, an electrical circuit is established between the center connectors 36 and 46 sooner during the travel of this plug, and an electrical signal can be transferred between these center conductors earlier than would otherwise be the case. Also, the force applied to the cam 78 by the spring 56 causes the cam 78 to apply a lateral biasing force against this plug to help keep this plug seated in the connector port 40 in spite of vibrations and/or shocks that may be applied to the dual self-terminating video jack 10.

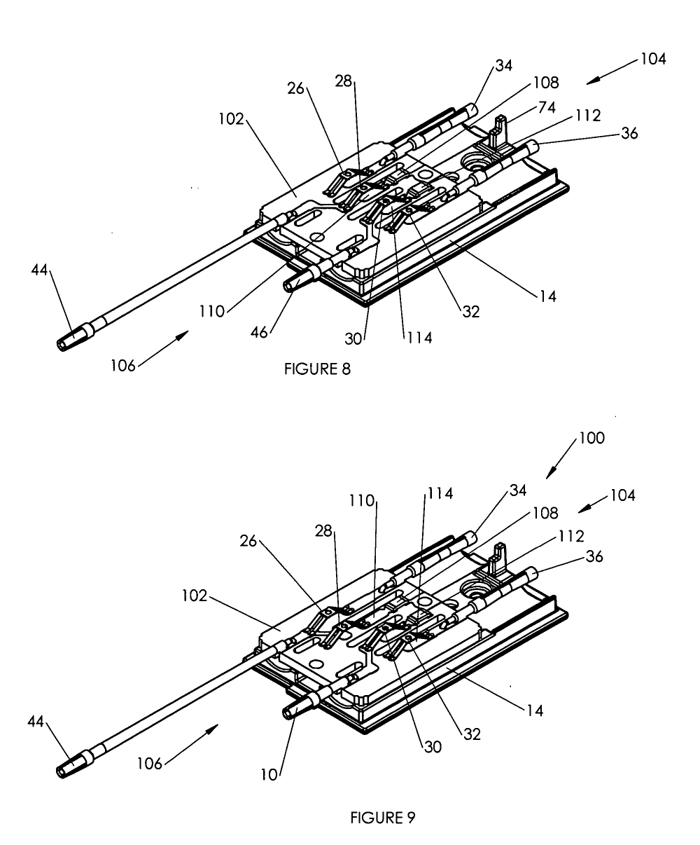

A dual straight-through video jack 100 according to another embodiment of the present invention is illustrated in FIGS. 1, 2, 5, 6, 7, 8 and 9. Thus, the only difference between the dual self-terminating video jack 10 and the dual straight-through video jack 100 is the printed circuit board. Accordingly, the same reference numerals are used when the same elements are depicted in the dual self-terminating video jack 10 and in the dual straight-through video jack 100.

The dual straight-through video jack 100 may include the housing 12 that can be closed with the cover 14. A printed circuit board 102 is fastened to the housing 12 by the screws 18 and 20. The sliders 22 and 24 are likewise provided within the housing 12 of the dual straight-through video jack 100. The sliding contacts 26 and 28 are suitably affixed to the slider 22, and the sliding contacts 30 and 32 are suitably affixed to the slider 24. Accordingly, the sliding contacts 26 and 28 may be moved relative to the printed circuit board 102, and the sliding contacts 30 and 32 may be separately moved relative to the printed circuit board 102.

The center conductors 34 and 36 are provided through corresponding connector ports at a first end 104 of the dual straight-through video jack 100, and the center conductors 44 and 46 are provided through corresponding connector ports at a second end 106 of the dual straight-through video jack 100.

A first terminating resistor 108 is coupled between a first conducting trace 110 on the printed circuit board 102 and the housing 12 through the screw 18. A second terminating resistor 112 is coupled between a second conducting trace 114 on the printed circuit board 102 and the housing 12 through the screw 18.

The spring 54 normally biases the slider 22 affixed to the sliding contacts 26 and 28 toward the first end 104 and away from the second end 106 of the dual straight-through video jack 100. Similarly, the spring 56 normally biases the slider 24 affixed to the sliding contacts 30 and 32 toward the first end 104 and away from the second end 106 of the dual straight-through video jack 100. Accordingly, the sliding contact 28 normally couples the center conductor 44 to ground through the first terminating resistor 108. Also, the sliding contact 30 normally couples the center conductor 46 to ground through the second terminating resistor 112. The center conductors 44 and 46 are in a normally open circuit condition.

The cams 78 and 80 can also be included in this embodiment.

When the plug 94 is inserted into the connector port 38 surrounding the center conductor 34 and engages the cam 80, the slider 22 moves the sliding contacts 26 and 28 to the positions shown in FIG. 9. Accordingly, the center conductors 34 and 44 are coupled together by the sliding contact 26 in combination with conducting traces on the printed circuit board 102. Movement of the slider 22 also causes the sliding contact 28 to disconnect the center conductor 44 from the first terminating resistor 108. However, because the sliding contacts 30 and 32 did not move, the center conductor 46 is still coupled to ground through the second terminating resistor 112, and the center conductor 36 is still in an open circuit condition.

Similarly, when a plug is inserted into the connector port 50 surrounding the center conductor 36 and engages the cam 78, the slider 24 moves the sliding contacts 30 and 32 so that the center conductors 36 and 46 are coupled together by the sliding contact 32 in combination with conducting traces on the printed circuit board 102. Movement of the slider 24 also causes the sliding contact 30 to disconnect the center conductor 46 from the second terminating resistor 112. However, because the sliding contacts 26 and 28 did not move, the center conductor 44 is still coupled to ground through the first terminating resistor 108, and the center conductor 44 is still in an open circuit condition.

Exemplary materials may be used as described in this paragraph. However, it should be understood that other materials could be used without departing from the scope of the present invention. Accordingly, the housing and cover may comprise a zinc alloy plated with nickel. The grounding clip may be beryllium copper finished with gold or nickel plating. The springs may be stainless steel springs, and/or may be compression springs or extension springs. The sliders may be polyetherimide. The sliding contacts may be beryllium copper finished with gold plating and further may be bifurcated as shown. The printed circuit boards may be PCB-Hydrocarbon having conducting traces made of copper finished with gold over nickel plating. The center connectors may be beryllium copper finished with gold plating. Each of the screws may be a steel alloy plated with zinc. The cams may be made of a suitable plastic.

The sliding contacts 26, 28, 30, and 32 are more reliable that the contacts typically used in prior art jacks, and the sliding contacts 26, 28, 30, and 32 perform better in dusty environments. Moreover, the grounding fins 64, 66, 68, 70, and 72 described above sufficiently isolate the sliding contacts and the conducting traces on the printed circuit board that cross-talk is materially reduced. Also, the springs 54 and 56 extend the life expectancy of video jacks over video jacks using leaf spring contacts. Furthermore, the use of a printed circuit board in the jacks allows the jacks to be easily re-configured for different applications. For example, a printed circuit board may configure a jack as a normalled jack with one or more terminating resistors, as a normalled jack without terminating resistors, as a non-normalled jack with one or more terminating resistors, or as a non-normalled jack without terminating resistors. The dual self-terminating video jack 10 is an example of a normalled jack, and the dual straight-through video jack 100 is an example of a non-normalled jack.

Certain modifications of the present invention have been disclosed above. Other modifications will occur to those practicing in the art of the present invention. For example, the video jacks described above may come in a variety of sizes.

Moreover, the video jacks described above may be used as audio and/or other jacks.

Furthermore, the terminating resistor 58 is used as the terminating element in the dual self-terminating video jack 10, and the terminating resistors 108 and 112 are used as the terminating elements in the dual straight-through video jack 100. Instead, other passive and/or active devices may be used as the terminating elements in the dual self-terminating video jack 10 and/or in the dual straight-through video jack 100.

Also, the jacks of the present invention may have any number of ports. For example, a jack in accordance with an embodiment of the present invention may have just two ports located at opposite ends of the housing and a sliding switch that has a first position in which the two ports are coupled together and a second position in which one of the two ports is coupled to a terminating element and the second port is open. As another example, a jack in accordance with another embodiment may have just three ports with two of the three ports located at one the end of the housing and the remaining port located at the opposite end of the housing. A sliding switch controls coupling of the first, second, and third ports.

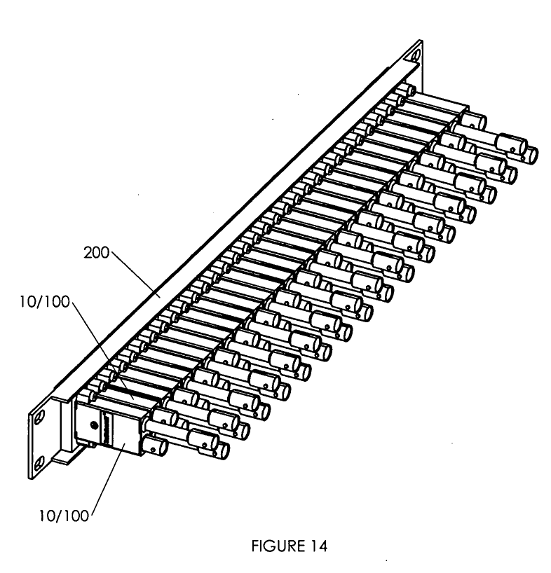

As shown in FIG. 14, the dual self-terminating video jack 10/100 has fasteners 120 and 122, which may be in the form of screws of bolts, for attaching the dual self-terminating video jack 10/100 to a patchbay 200.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

1. A switching coaxial jack comprising:
an electrically groundable housing supporting first and second connectors at a first end of the housing and third and fourth connectors at a second end of the housing;
a first center conductor disposed within the first connector;
a second center conductor disposed within the second connector;
a third center conductor disposed within the third connector;
a fourth center conductor disposed within the fourth connector;
a terminating element within the housing;
a switch within the housing having a first position that electrically couples the third center conductor to one of the fourth center conductor and the terminating element and a second position that electrically couples the first and third center conductors to one another; and,
a cam within the housing such that a plug, inserted into one of the connectors, causes the cam to operate the switch between the first and second positions and causes the cam to apply a lateral biasing force against the plug when the plug is in the one connector.

2. The switching coaxial jack of claim 1 wherein the switch comprises:
a printed circuit board having conducting traces; and,
sliding contacts that slide over the conducting traces.

3. The switching coaxial jack of claim 2 wherein the housing comprises fins that extend through corresponding openings in the printed circuit board so as to electrically isolate the sliding contacts from one another.

4. The switching coaxial jack of claim 1 wherein the housing comprises fins that electrically isolate contacts of the switch.

5. The switching coaxial jack of claim 1 wherein the switch, in the first position, electrically couples the third center conductor to the terminating element and, in the second position, electrically couples the first and third center conductors to one another.

6. The switching coaxial jack of claim 1 wherein the switch, in the first position, electrically couples the third center conductor to the fourth center conductor and, in the second position, electrically couples the first and third center conductors to one another.

7. The switching coaxial jack of claim 1 wherein the switch comprises first, second, third, and fourth contacts, wherein the first and fourth contacts provide no circuit connection when the switch is in the first position, wherein the second and third contacts electrically couple the third and fourth center conductors to one another when the switch is in the first position, wherein the first contact electrically couples the first and third center conductors to one another when the switch is in the second position, wherein the second and third contacts electrically couple the fourth center conductor to the terminating element when the switch is in the second position, and wherein the fourth contact provides no circuit connection when the switch is in the second position.

8. The switching coaxial jack of claim 1 wherein the switch comprises first, second, third, and fourth contacts, wherein the terminating element comprises first and second terminating elements, wherein the first and fourth contacts provide no circuit connection when the switch is in the first position, wherein the second contact electrically couples the third center conductor to the first terminating element when the switch is in the first position, wherein the third contact electrically couples the fourth center conductor to the second terminating element when the switch is in the first position, wherein the first contact electrically couples the first and third center conductors to one another when the switch is in the second position, wherein the second and fourth contacts provide no circuit connection when the switch is in the second position, and wherein the third contact electrically couples the fourth center conductor to the second terminating element when the switch is in the second position.

9. The switching coaxial jack of claim 1 wherein the cam comprises a first cam, wherein the switching coaxial jack comprises a second cam, wherein the first cam is responsive to a plug inserted into the first connector, and wherein the second cam is responsive to a plug inserted into the second connector.

10. The switching coaxial jack of claim 1 further comprising a non-contact spring within the housing to bias the switch toward the first position.

11. The switching coaxial jack of claim 1 further comprising a patchbay coupled to at least one of the first, second, third, and fourth connectors.

12. A switching coaxial jack comprising:
an electrically groundable housing supporting at least first, second, and third coaxial connectors, wherein the first coaxial connector includes a first center conductor disposed therein, wherein the second coaxial connector includes a second center conductor disposed therein, and wherein the third coaxial connector includes a third center conductor disposed therein;
a switch within the housing movable between first and second positions so as to control switching of the first, second, and third center conductors, wherein the switch is location within the housing such that the switch could be operated directly by a plug inserted into one of the connectors; and,
a cam within the housing, wherein the cam interacts with the plug such that a plug, inserted into one of the connectors, causes the cam to operate the switch between the first and second positions sooner than if the cam were not present in the housing.

13. The switching coaxial jack of claim 12 wherein the switch comprises:
a printed circuit board having conducting traces; and,
sliding contacts that slide over the conducting traces.

14. The switching coaxial jack of claim 13 wherein the housing comprises fins that extend through corresponding openings in the printed circuit board so as to electrically isolate the sliding contacts from one another.

15. The switching coaxial jack of claim 12 wherein the housing comprises fins that electrically isolate contacts of the switch.

16. The switching coaxial jack of claim 12 wherein the switch, in the first position, electrically couples the second center conductor to a terminating element, and wherein the switch, in the second position, electrically couples the first and third center conductors to one another.

17. The switching coaxial jack of claim 12 wherein the switch, in the first position, electrically couples the second center conductor to the third center conductor, and wherein the switch, in the second position, electrically couples the first and second center conductors to one another and.

18. The switching coaxial jack of claim 12 wherein the switch comprises first, second, and third contacts, wherein the first contact provides no circuit connection when the switch is in the first position, wherein the second and third contacts electrically couple the second and third center conductors to one another when the switch is in the second position, wherein the first contact electrically couples the first and second center conductors to one another when the switch is in the second position, and wherein the second and third contacts electrically couple the third center conductor to a terminating element when the switch is in the second position.

19. The switching coaxial jack of claim 12 further comprising first and second terminating elements, wherein the switch comprises first, second, and third contacts, wherein the first contact provides no circuit connection when the switch is in the first position, wherein the second contact electrically couples the second center conductor to the first terminating element when the switch is in the first position, wherein the third contact electrically couples the third center conductor to the second terminating element when the switch is in the first position, wherein the first contact electrically couples the first and second center conductors to one another when the switch is in the second position, wherein the second contact provides no circuit connection when the switch is in the first position, and wherein the third contact electrically couples the third center conductor to the second terminating element when the switch is in the second position.

20. The switching coaxial jack of claim 12 further comprising a non-contact spring within the housing to bias the switch toward the first position.

21. The switching coaxial jack of claim 12 wherein the cam is arranged such that the plug, inserted into one of the connectors, causes the cam to apply a lateral biasing force against the plug when the plug is in the one connector.

22. The switching coaxial jack of claim 12 further comprising a patchbay coupled to at least one of the first, second, and third coaxial connectors.

23. A switching coaxial jack comprising:
an electrically groundable housing supporting at least first, second, and third coaxial connectors, wherein the first coaxial connector includes a first center conductor disposed therein, wherein the second coaxial connector includes a second center conductor disposed therein, and wherein the third coaxial connector includes a third center conductor disposed therein;
a switch within the housing movable between first and second positions so as to control switching of the first, second, and third center conductors; and,
a cam within the housing, wherein the cam comprises a cam surface and a projection projecting away from the cam surface, wherein the cam surface projection are arranged to rotate about a common axis such that the projection operates the switch and the cam surface applies a lateral biasing force against a plug when the plug is inserted into one of the connectors, and wherein respect to one another along the common axis.

24. The switching coaxial jack of claim 23 wherein the switch comprises:
a printed circuit board having conducting traces; and,
sliding contacts that slide over the conducting traces, wherein the sliding contacts slide over the conducting traces in order to control switching of the first, second, and third center conductors.

25. The switching coaxial jack of claim 23 wherein the housing comprises fins that electrically isolate contacts of the switch.

26. The switching coaxial jack of claim 23 wherein the switch, in the first position, electrically couples the second center conductor to a terminating element, and in the second position, electrically couples the first and second center conductors to one another.

27. The switching coaxial jack of claim 23 wherein the switch, in the first position, electrically couples the second center conductor to the third center conductor, and in the first position, electrically couples the first and second center conductors to one another.

28. The switching coaxial jack of claim 23 wherein the switch comprises first, second, and third contacts, wherein the first contact provides no circuit connection when the switch is in the first position, wherein the second and third contacts electrically couple the second and third center conductors to one another when the switch is in the second position, wherein the first contact electrically couples the first and second center conductors to one another when the switch is in the second position, and wherein the second and third contacts electrically couple the third center conductor to a terminating element when the switch is in the second position.

29. The switching coaxial jack of claim 23 further comprising first and second terminating elements, wherein the switch comprises first, second, and third contacts, wherein the first contact provides no circuit connection when the switch is in the first position, wherein the second contact electrically couples the second center conductor to the first terminating element when the switch is in the first position, wherein the third contact electrically couples the third center conductor to the second terminating element when the switch is in the first position, wherein the first contact electrically couples the first and second center conductors to one another when the switch is in the second position, wherein the second contact provides no circuit connection when the switch is in the second position, and wherein the third contact electrically couples the third center conductor to the second terminating element when the switch is in the second position.

30. The switching coaxial jack of claim 23 further comprising a non-contact spring within the housing to bias the switch toward the first position.

31. The switching coaxial jack of claim 23 further comprising a patchbay coupled to at least one of the first, second, and third coaxial connectors.

32. A switching coaxial jack comprising:
an electrically groundable housing supporting first and second connectors at a first end of the housing and third and fourth connectors at a second end of the housing;
a first center conductor disposed within the first connector;
a second center conductor disposed within the second connector;
a third center conductor disposed within the third connector;
a fourth center conductor disposed within the fourth connector,
a switch within the housing having first and second positions to electrically interconnect various ones of the first, second, third, and fourth center conductors, wherein the switch moves between the first and second positions essentially in parallel to the first, second, third, and fourth center conductors;
a spring contacting the switch so as to bias the switch in one of the first and second positions; and,
a cam within the housing contacting the switch but not the spring such that a plug, inserted into one of the connectors, causes the cam to operate the switch to the other of the first and second positions and causes the cam by action of the spring to apply a lateral biasing force against the plug when the plug is in the one connector.

33. The switching coaxial jack of claim 32 wherein the cam comprises a cam surface and a projection projecting away from the cam surface, wherein the projection pushes the switch against the action of the spring and the cam surface applies the lateral biasing force against the plug when the plug is inserted into the one connector.
